(19) United States
(12) Patent Application Publication
(10) Pub. No.: US 2012/0074669 A1
(43) Pub. Date: Mar. 29, 2012

(54) PIVOTING JOINT FOR AN ARTICULATED VEHICLE

(75) Inventors: Lothar Scharf, Bad Sooden-Allendorf (DE); Robert Koch, Bad Sooden-Allendorf (DE)

(73) Assignee: Hubner GmbH, Kassel (DE)

(21) Appl. No.: 13/205,707

(22) Filed: Aug. 9, 2011

(30) Foreign Application Priority Data
Sep. 24, 2010 (DE) 102010046495.3-21

(51) Int. Cl. B60D 1/02

(52) U.S. Cl. 280/515

(57) ABSTRACT

The subject matter of the invention is a pivoting joint for an articulated vehicle comprising two joint segments connected by at least one joint body, wherein the joint body comprises at least one saddle having at least one concave bowed surface, which is received by the first joint segment, wherein the joint body furthermore comprises at least one calotte disposed on the other second joint segment, wherein the calotte faces the concave bowed surface of the saddle with its convex bowed surface, wherein the calotte and saddle are connected by means of a pin to each other, wherein a bearing liner with at least one layer made of elastomer is disposed between the saddle and the calotte.

### CROSS-REFERENCE TO RELATED APPLICATIONS

This application claims priority of German Patent Application DE 10 2010 046 495.3-21 filed Sep. 24, 2010.

### FIELD OF THE INVENTION

The invention relates to a pivoting joint for an articulated vehicle, comprising two joint segments connected by at least one joint body according to the preamble of claim 1.

### BACKGROUND OF THE INVENTION

An articulated vehicle of numerous sections that can be coupled together is sufficiently known from the prior art. The sections of an articulated vehicle of this sort are coupled by means of a pivoting joint. A bellows, wherein a bridge is provided for persons moving from one vehicle section to another, typically spans the pivoting joint.

The definition of the pivoting joint in this case comprises the entire assembly between the two vehicle sections. As is known, articulated vehicles are subjected to all types of motion. Thus, the pivoting joint must be capable of accommodating rolling, pitch, and articulated motions. Rolling motions are understood to mean motions whereby the two vehicle sections rotate in relation to one another along the longitudinal axis. Articulated motions are those that occur when the articulated vehicle drives around a curve with the two vehicle sections, while pitch motions in contrast, occur when an articulated vehicle drives over a dip or a crest.

A known pivoting joint connection, which allows for the types of motion specified above as well as superimposed types of motion, comprises a so-called swing bearing joint with two pivotal rings mounted one inside the other, wherein one of the rings, usually the inner ring, is designated for the front carriage, while the second ring, usually the outer ring, is designated for the rear carriage. For this, the outer ring rests atop the inner ring, whereby the two rings can rotate against one another about a vertical axis in order to accommodate for articulated motions when the vehicle drives, for example, through a curve.

Pitch motions are allowed for in that one of the two vehicle sections is connected to a rubber cushioned hinged joint aligned at a right angle to the longitudinal axis of the vehicle. This is usually the front carriage, which is connected to the swing bearing joint at said pivotal ring by metal-rubber bearings of this type.

As long as two metal-rubber bearings are provided on both sides of the central longitudinal axis, it is advantageous that they each have an axle pin, which lies at a right angle to the longitudinal axis of the vehicle. The axle pin is encased in a rubber sleeve, which in turn is encased in a sleeve jacket, wherein the axle pin establishes the connection to the pivotal ring, and the sleeve establishes the connection to the vehicle section. Rolling motions that occur are accommodated, on the one hand, by the chassis of the vehicle, and, on the other hand, by the metal-rubber bearings.

Furthermore, an articulated joint is known from EP 1916181, wherein the two joint segments are connected to one another by means of a bucking bearing. One joint segment is attached to the one carriage body thereby, while the other joint segment is attached to the opposite carriage body. The other joint segment comprises a so-called rolling joint body for accommodating pitch and rolling motions, which is contained in a housing sleeve. For this, the rolling joint body has a joint body designed along the lines of a ball, which is received in two elastomer cushions through the housing sleeve. The rolling joint body has stub shafts at each end, by means of which the rolling joint body, and thereby also the entire bearing, is attached to the body of the carriage. This combined pitch and rolling bearing is, as the name already indicates, capable, due to the elastic bearing of the rolling joint body in the housing sleeve, of accommodating both rolling motions as well as pitch type motions. A similar design is known from EP 1916180. The two latter joints can be produced at relatively economical prices, and they can be implemented in particular in vehicles with which large articulation angles are allowed for, as is, for example, the case with busses. In contrast, smaller articulation angles are required for rail vehicles.

A pivoting joint belonging to this family of joints is described in DE 20 2006 004 643 U1. In this case, two joint segments of a pivoting joint for an articulated vehicle are known, which are connected to one another by means of a joint body. The joint body comprises a calotte located on a pin, wherein the pin is connected to a joint segment. The other joint segment has a saddle with a concave surface corresponding to the calotte, wherein the saddle contains the calotte.

### SUMMARY OF THE INVENTION

The objective of the invention consists thereby of producing a pivoting joint capable of accommodating all of the driving motions occurring, such as, for example, rolling, pitch and articulated motions as well as overlapping motions of the types specified above, and which furthermore can be produced at extremely economical prices. In particular, the design should be structurally simple, and consist of only a few components.

To attain the objective according to the invention, a pivoting joint for an articulated vehicle of the type describe above is proposed, with a bearing liner having at least one layer of an elastomer located between the saddle and the calotte. From this it is clear that the pivoting joint has no rotational components in the basic sense, as is the case in the prior art, and moreover, the articulated motions between the two vehicle sections of an articulated vehicle are enabled solely by means of the elastomer components. The subject matter of the invention is thereby a spherical bearing, wherein an elastic intermediate joint is disposed between the calotte, as one part of the spherical bearing, and the saddle, as the other part of the spherical bearing, whereby the elastic intermediate joint is clamped between the calotte on one hand, and the saddle, on the other hand. Not only the articulated type motions, but also rolling and pitch motions, such as may occur between two vehicles connected pivotally, are accommodated by said elastomer layer, as has already been described above. The joint body according to the invention is extremely economical in terms of production costs, and furthermore, robust, such that it is suited in particular for implementation with articulated busses, as well as with rail vehicles.

Advantageous characteristics and embodiments of the invention are to be derived from the dependent claims.

As such, it is intended, according to an advantageous embodiment, that the joint body have a calotte on each side, whereby the saddle is disposed between the calottes, having a concave bowed surface on each side, wherein at least one elastomer layer is provided in each case between the calotte and the saddle of the bearing liner, whereby the two calottes are connected by the pins. The result is, on the one hand, an absolutely symmetrical bearing, wherein a relatively large articulation angle is available as a result of the two bearing liners at both sides of the saddle between the two calottes, which allows for rolling and pitch motions to a significant degree as well.

Specifically, it is furthermore provided that the radius of the concave bowed surface of the saddle is different than the radius of the convex bowed surface of the calotte. In particular it is intended in this context that the radius of the calotte is smaller than the radius of the saddle. As a result, the possibility exists for the bearing liner, having at least one elastomer layer located between the calotte and the saddle, is designed such that it is increasingly thicker towards the outer edge. This is advantageous in that it enables one to maintain a constant tension in the layer over the entire surface. Because the tension is naturally greater at the outer edges when subjected to loads than at the inner edges, an increased volume in the elastomer layer at the outer edges decreases the tension there, such that the tension is substantially the same at all points on the elastomer layer.

According to a particularly advantageous characteristic of the invention, it is provided that the elastomer body comprises at least two elastomer layers, wherein a bowed plate is located between the layers, whereby the radius of the bowed plate is greater than the radius of the calotte but smaller than the radius of the saddle. From this it can be directly derived that an elastomer layer is provided both above and below the plate, whereby the lower elastomer layer is thicker than the upper elastomer layer. In particular, the lower elastomer layer is thicker than the upper layer at the edges. It is advantageous that the layer below the plate is thicker than the layer above the plate. This asymmetric distribution of the two elastomer layers is also due to the requirement that the tensions in the two elastomer layers should be the same over the course of the entire elastomer layer. Equally, through the disposal of two or, as the case may be, even more elastomer layers, and correspondingly more plates, not only is an increase in the articulated angle enabled, but greater rolling and pitch motions can also be accommodated. The elastomer layers are thereby permanently attached to the plates by means of vulcanization, for example.

In order to provide for greater articulation angles without damaging the bearing liner having the, at least one, elastomer layer, according to a particularly advantageous characteristic, there is no permanent connection, such as by vulcanization, for example, between the calotte and the elastomer layer, but instead a sliding of the components against one another is to be enabled. Depending on the tension applied to the bearing liner through the connection between the calotte and the saddle, a breakaway torque can be set which allows the calotte or saddle and bearing liner to move in relation to one another in a sliding manner. In this manner, damage to the elastomer layers of the bearing liner is prevented when subjected to large articulation angles. Specifically, it may be seen to be advantageous that a sliding surface is provided between the bearing liner on one side, and the calotte and/or saddle on the other side, made, for example, of Teflon, in order to affect the breakaway torque when the pivoting joint is subjected to loads while driving through a curve.

It is basically the case that a sliding relative motion between the calotte and bearing liner and/or between the saddle and the bearing liner should only be incorporated in the case where the load to the, at least one, elastomer layer is to be so large that there is reason to fear a tearing and thereby damage to the bearing liner. Basically it is the case that the bearing liner can be permanently attached to the calotte and/or the saddle by means of, for example, vulcanization, if the articulation angle is always to remain within the range that can be sustained by the bearing liner.

It has already been pointed out elsewhere that one problem in the use of elastomer layers for the production of bearing liners for a joint is that the tensions in the individual elastomer layers must be kept substantially constant. This means that the tensions in the respective elastomer layers should be substantially the same at all points. It is for this reason that according to another characteristic of the invention the, at least one, elastomer layer is bowed in a concave manner at the edges. Should the elastomer layer or layers be subjected to loads while an articulated vehicle of this type is being driven, then there is always the possibility that, depending on the respective type of load, the respective elastomer layer will be subjected to a load on one side, and relieved of said load on the other side, i.e. it will be asymmetrically loaded. With a load, the loaded elastomer layer has the tendency to bulge outwards. By means of a concave bowing of the elastomer layer when not in motion, it is possible to ensure that even when subjected to loads, the elastomer layer will not form a convex outwards bulge; convex bulging of the outer surfaces of an elastomer layer can lead to the danger of tearing, as the tensions increases in the convex bulging areas. For the same reasons, the same applies to the design of a concave bowing in the, at least one, elastomer layer on the pin surface.

A further distinguishing characteristic is that the distance between the calottes can be adjusted by means of a spacer sleeve. By this means it is established that the assembly is simplified in that the bearing liner can only be pre-loaded to a certain degree.

Furthermore it is provided that the bearing liner has a radial distance to the pin or the spacing sleeve. This is to ensure that when loaded axially, as is the case when braking and starting up, the bearing liner does not lie against the sleeve or the pin. In this case, it is also provided that the saddle has a radial distance to the pin or the spacing sleeve in order to, as already explained, prevent the saddle from abutting the spacing sleeve or the pin, while braking or starting up. As a result, it is clear that the saddle must, by definition, be supported freely within the body of the joint. The distance in this case is measured such that when a part of the joint body comes in contact with the pin or the sleeve, the tension in the elastomer layers is such that they do not tear.

Furthermore, it is provided, according to a characteristic of the invention, that the pin is designed as a threaded bolt, whereby the one calotte has a threading for the threaded bolt.

### BRIEF DESCRIPTION OF THE DRAWINGS

Based on the drawings, the invention shall be explained in greater detail below.

FIG. 1 shows a side view of the joint according to the invention;

FIG. 2 shows a top view;

FIG. 3 shows a cut along the line III-III in FIG. 2.

### DETAILED DESCRIPTION OF THE PREFERRED EMBODIMENTS

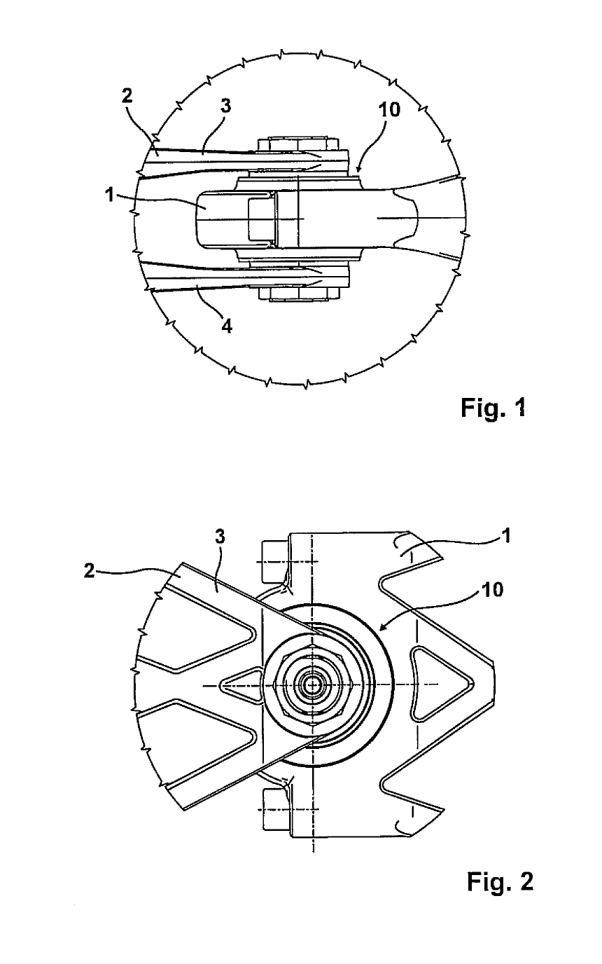

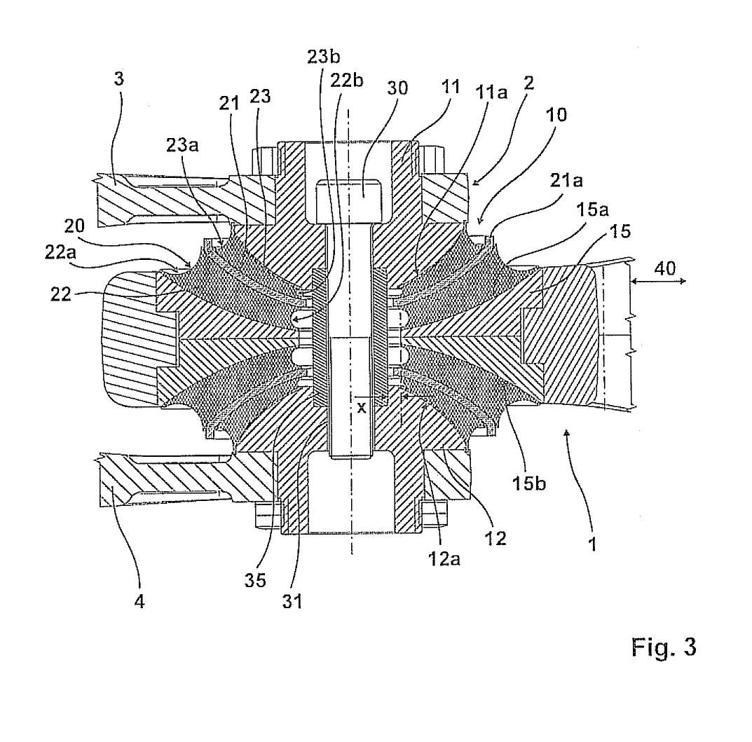

According to FIG. 1, the first joint segment is indicated with the numeral 1, and the second joint segment is indicated by the numeral 2. The first joint segment is located between the legs 3 and 4 of the second joint segment 2. The connection of the first joint segment to the second joint segment is made by means of the joint body indicated by the numeral 10. The joint body 10 formed by the connection between the two joint segments 1 and 2 shall be described below based on FIG. 3.

The joint body 10 comprises the two calottes 11 and 12. The saddle, indicated by the numeral 15, is located between the two calottes 11 and 12. The saddle 15 has two bowed concave surfaces 15a and 15b, which face the convex bowed surfaces 11a and 12a of the respective calottes 11, 12. The bearing liner, indicated by the numeral 20, is located between the convex bowed surface 11a of the calotte 11, or the convex bowed surface 12a of the calotte 12, respectively, and the saddle 15. The bearing liner 20 features a bowed plate 21, wherein there is an elastomer layer 22, 23 located on the upper and lower surface, respectively, of the plate 21. The two elastomer layers are connected to the plate 21 by means of vulcanization. The elastomer layer 22 is thicker than the elastomer layer 23.

The reason for this can be found in that the lower elastomer layer is subjected to heavier loads, due to the structure of the joint, than the upper layer. The different dimensions of the elastomer layers are provided in order to maintain the tensions within a sustainable level for the elastomer. Both the elastomer layer 22 as well as the elastomer layer 23 have a concave bowing at the edges (arrows 22a, 23a, or 22b, 23b) which ensures that when the bearing liner is compressed, the elastomer layers will not display a convex bulging, because a convex bulging of the layers when subjected to loads is more likely to result in tearing than with a concave bowing. This applies to both the outer and inner regions of the layers.

The two calottes 11, 12 are held together by a threaded bolt 30. The one calotte, specifically the calotte 12, is fitted with a threading 31 for receiving the threaded bolt. A spacing sleeve 35 connects the two calottes. The spacing sleeve 35 ensures that the calottes are not compressed beyond a certain point for the assembly of the bearing liner 20 with the elastomer layers 22, 23. A sliding surface 25, made, for example of Teflon, can be provided between the bearing liner 20 and the calotte and/or the saddle 15. The sliding surface enables the bodies to slide against each other when the torque generated between the calotte and the saddle by the articulation angle between vehicle sections is greater than the breakaway torque between the calotte/saddle and the elastomer layer(s) of the bearing liner, in order to prevent damage to the bearing liner 20, specifically to the elastomer layer(s) in this case. This means that the sliding surface ensures that, when subjected to extreme loads, the bearing liner will not be damaged. At the same time, the spacing sleeve also serves as a stop for the plate 21, the saddle 15 and the two elastomer layers 22, 23 on both sides of the plate 21. The plate 21 has a turned out bead 21a, which serves to receive the vulcanizing tool.

The calottes 11, 12 rest against the spacing sleeve 35. This is in contrast to the bearing liner 20 and the saddle 15. The saddle 15 is at a distance x to the sleeve, in the same manner that the plate 21 is radially separated from the spacer sleeve 35. The elastomer layers 22, 23 are also separated from the spacer sleeve. When braking or starting to drive the vehicle, the bearing liner 20, resting on the saddle 15, which in turn is connected to the first joint segment, is to compensate for the stress exerted in the direction of the arrow 40. The previously described spaces are provided in order to prevent the components of the bearing liner 20 and the saddle 15 from coming in contact with the spacer sleeve 35. The dimensions of the spacing x have been selected to be large enough that when the elastomer layers rest against the sleeve, the tension will not be so great that tears may occur.

1. A pivoting joint for an articulated vehicle comprising two joint segments, connected by at least one joint body, wherein the joint body comprises at least one saddle having at least one concave bowed surface, which is received by a first joint segment, wherein the joint body comprises furthermore at least one calotte located on the other second joint segment, wherein the calotte faces the concave bowed surface of the saddle with its convex bowed surface, wherein the calotte and saddle are connected by a pin, characterized in that a bearing liner with at least one layer of elastomer is disposed between the saddle and the calotte.

2. The pivoting joint for an articulated vehicle according to claim 1, characterized in that the joint body has a calotte on each side, wherein the saddle is disposed between the calottes, having a concave bowed surface on each side, wherein the bearing liner with the, at least one, layer made of elastomer is located between the calotte and the saddle respectively, wherein the two calottes are connected by the pin.

3. The pivoting joint for an articulated vehicle according to claim 1, characterized in that the radius of the concave bowed surface of the saddle is different than the radius of the convex bowed surface of the calotte.

4. The pivoting joint for an articulated vehicle according to claim 1, characterized in that the radius of the convex bowed surface of the calotte is smaller than the radius of the concave bowed surface of the saddle.

5. The pivoting joint for an articulated vehicle according to claim 1, characterized in that the bearing liner comprises at least two elastomer layers, wherein a bowed plate is located between the layers, wherein the radius of the bowing of the plate is greater than that of the calotte, but smaller than the concave bowed surface of the saddle.

6. The pivoting joint for an articulated vehicle according to claim 5, characterized in that the elastomer layers are permanently attached to the plate.

7. The pivoting joint for an articulated vehicle according to claim 1, characterized in that the, at least one, elastomer layer is permanently attached to the calotte.

8. The pivoting joint for an articulated vehicle according to claim 1, characterized in that the calotte and/or saddle can slide against the bearing liner.

9. The pivoting joint for an articulated vehicle according to claim 8, characterized in that a sliding surface is disposed between the bearing liner and the calotte and/or saddle.

10. The pivoting joint for an articulated vehicle according to claim 1, characterized in that the, at least one, elastomer layer has a convex bowing at the edges.

11. The pivoting joint for an articulated vehicle according to claim 2, characterized in that the distance between the calottes can be defined by a spacing sleeve.

12. The pivoting joint for an articulated vehicle according to claim 1, characterized in that the bearing liner exhibits a radial distance to the pin or the spacing sleeve.

13. The pivoting joint for an articulated vehicle according to claim 1, characterized in that the saddle exhibits a radial distance to the pin or the spacing sleeve.

14. The pivoting joint for an articulated vehicle according to claim 1, characterized in that the pin is designed as a threaded bolt, wherein one calotte has a threading for receiving the threaded bolt.

15. The pivoting joint for an articulated vehicle according to claim 1, characterized in that the first joint segment is held between the legs of the other second, U-shaped joint segment by the joint body.
